(19) United States
(12) Patent Application Publication
(10) Pub. No.: US 2011/0018789 A1
(43) Pub. Date: Jan. 27, 2011

(54) Liquid Crystal Module

(76) Inventor: Chi-Ming Tseng, Taipei (TW)

Correspondence Address: Lin & Associates;Intellectual Property, Inc., PO Box 2339, Saratoga, CA, 95070-0339, US

(21) Appl. No.: 12/507,798

(22) Filed: Jul. 23, 2009

(51) Int. Cl. G09G 3/36

(52) U.S. Cl. 345/87

(57) ABSTRACT

A liquid crystal module includes a liquid crystal panel, a plastic frame enclosing a periphery of the liquid crystal panel and a metal shell coupled with the plastic frame. A plurality of aseismatic portions are protruded outwards from at least one of the plastic frame and the metal shell. The aseismatic portions are capable of contacting an outer hard means foremost and are resiliently compressed to buffer an impacting force applied to the liquid crystal module, when the liquid crystal module knock against the outer hard means.

### BACKGROUND OF THE INVENTION

1. Field of the Invention

The invention relates to a liquid crystal module, and more particularly to a liquid crystal module having an impact-proof structure.

2. The Related Art

Due to the recent improvements in liquid crystal materials and micro-fabrication technologies, liquid crystal modules (LCMs) are lightweight, thin profile, and low power consumption. The LCMs are currently used as display devices in various applications, such as slim and lightweight Notebook Personal Computers (NTPC). The LCM mainly has a frame constructed by flexible material, a liquid crystal panel provided in the frame and a metal shell of shielding effect coupled with the frame. Meanwhile, the frame serves as the impact-proof structure which can protect the liquid crystal panel from directly contacting an outer hard means, for example, when the LCM accidentally falls down or knocks against other hard means or the like. However, since the frame is rigid and can not buffer the impacting force, the liquid crystal module will be applied with the intense impacting force and the internal liquid crystal panel may be damaged.

### SUMMARY OF THE INVENTION

An object of the present invention is to provide a liquid crystal module having an impact-proof structure capable of preventing the liquid crystal module from damaging. The liquid crystal module includes a liquid crystal panel, a plastic frame enclosing a periphery of the liquid crystal panel and a metal shell coupled with the plastic frame. A plurality of aseismatic portions are protruded outwards from at least one of the plastic frame and the metal shell. The aseismatic portions are capable of contacting an outer hard means foremost and are resiliently compressed to buffer an impacting force applied to the liquid crystal module, when the liquid crystal module knocks against the outer hard means.

As described above, the liquid crystal module has the aseismatic portions. When the liquid crystal module knocks against the outer hard means, the aseismatic portions firstly contact the outer hard means to buffer the impacting force applied to the liquid crystal module because of the resilient deformation thereof, which will protect the liquid crystal panel from damaging.

### BRIEF DESCRIPTION OF THE DRAWINGS

The present invention will be apparent to those skilled in the art by reading the following description, with reference to the attached drawings, in which:

FIG. 1 is a perspective view of a liquid crystal module in a first embodiment according to the present invention;

FIG. 2 is a partly enlarged view showing an enlarged IV portion of FIG. 1;

FIG. 3 is a perspective view of a liquid crystal module in a second embodiment according to the present invention;

FIG. 4 is a partly enlarged view showing an enlarged IV portion of FIG. 3;

FIG. 5 is a perspective view of a liquid crystal module in a third embodiment according to the present invention; and

FIG. 6 is a partly enlarged view showing an enlarged VI portion of FIG. 5.

### DETAILED DESCRIPTION OF THE EMBODIMENTS

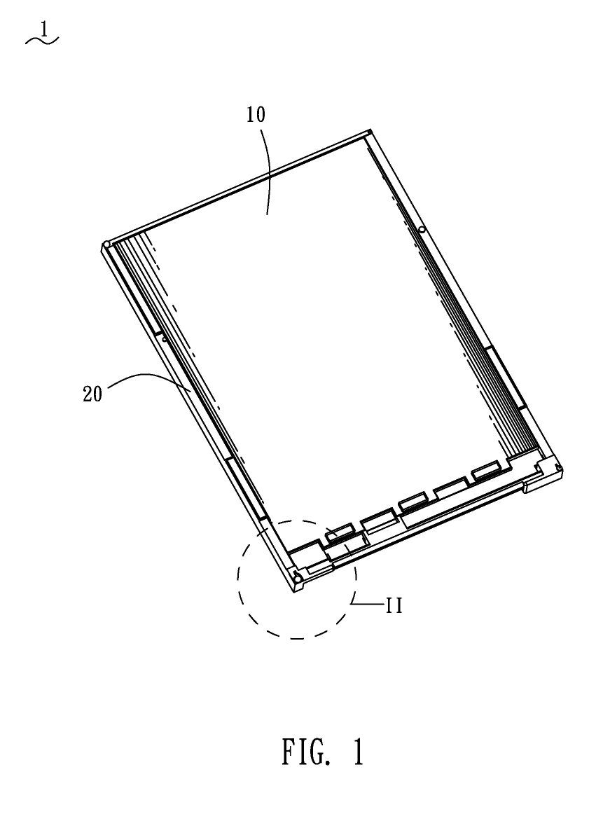

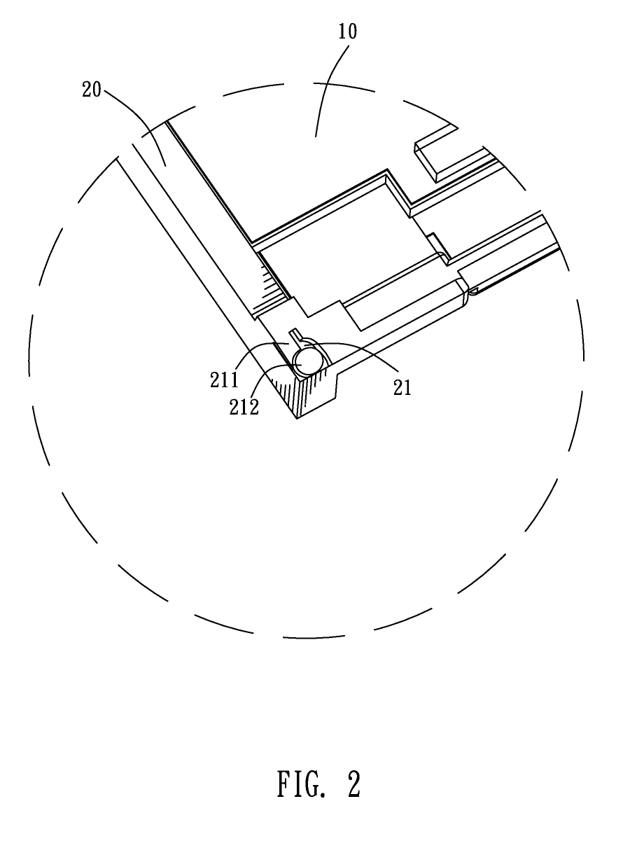

Please refer to FIG. 1 and FIG. 2, a liquid crystal module 1 of the first embodiment according to the present invention is shown. The liquid crystal module 1 has a rectangular liquid crystal panel 10, a plastic frame 20 enclosing a periphery of the liquid crystal panel 10 and a metal shell (not shown) of shielding effect coupled with the frame 20. The frame 20 has four grooves 21 arranged at four corners of a top surface thereof. Four elastic arms 211 each extend from a side of the groove 21 and suspend over the corresponding groove 21 thereof. An aseismatic portion 212 of semi-sphere shape is projected upwards from a free end of the elastic arm 211. When the liquid crystal module 1 knocks against an outer hard component (not shown), the aseismatic portion 212 will contact the outer hard component foremost and be resiliently pressed downwards to move inside the groove 21 with a limited range, which is effective to buffer an impacting force applied to the liquid crystal module 1. Consequently, the liquid crystal panel 10 avoids the intense shock from damaging the internal components thereof.

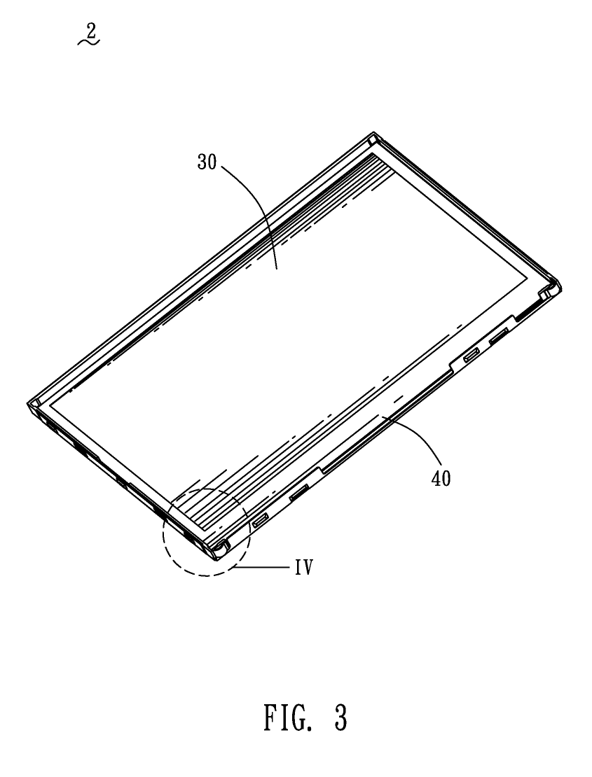

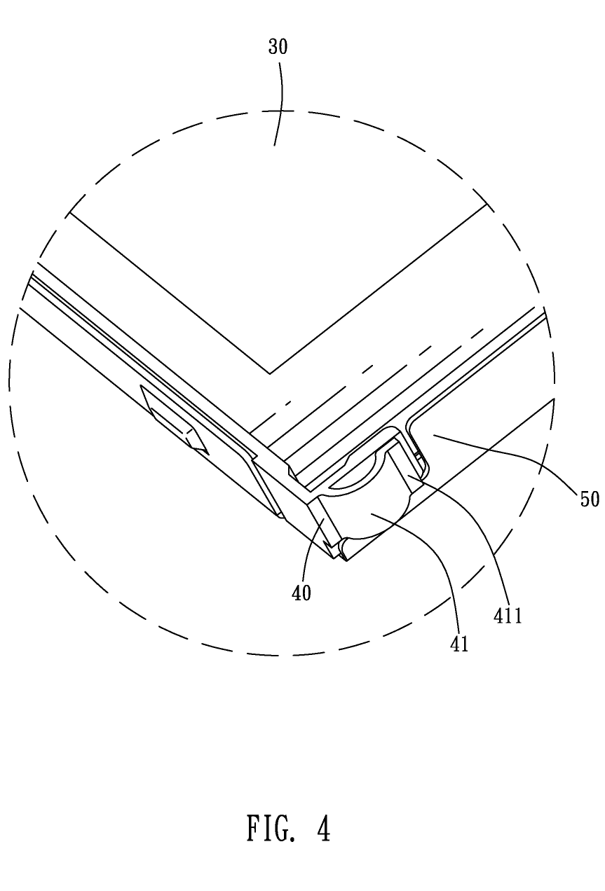

Please refer to FIG. 3 and FIG. 4, a liquid crystal module 2 of the second embodiment according to the present invention is shown. The liquid crystal module 2 has a rectangular liquid crystal panel 30, a plastic frame 40 enclosing a periphery of the liquid crystal panel 30 and a metal shell 50 of shielding effect covered on mostly outer surfaces of the frame 40. The plastic frame 40 is also rectangular. A lateral side of the plastic frame 40 has a portion extended outwards and bent towards the corresponding lateral side to form an aseismatic portion 41 of arc shape. The aseismatic portion 41 has a free end bent opposite to the aseismatic portion 41 to form a contacting portion 411 of a flat slice shape, attaching on the corresponding lateral side and capable of sliding freely thereon. In this embodiment, there are two aseismatic portions 41 at two ends of each of two opposite long lateral sides of the plastic frame 40. Each of the aseismatic portions 41 extends along a longitudinal direction of the plastic frame 40. When the liquid crystal module 2 knocks against the outer hard component, the aseismatic portion 41 will firstly contact the outer hard component to make the contacting portion 411 move a distance along the lateral side of the frame 40, which is effective to buffer an impacting force applied to the liquid crystal module 2. Consequently, the liquid crystal panel 30 avoids the intense shock to damage internal components thereof.

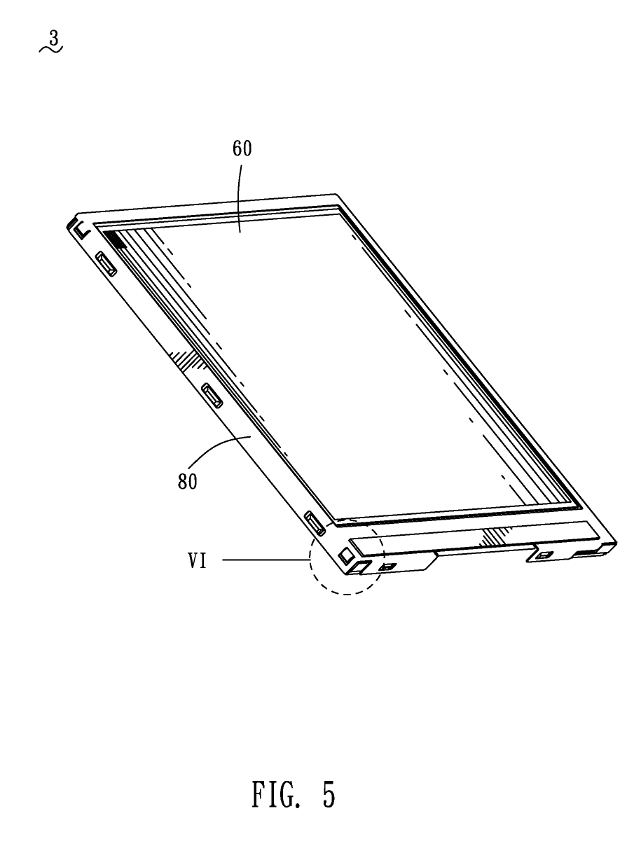

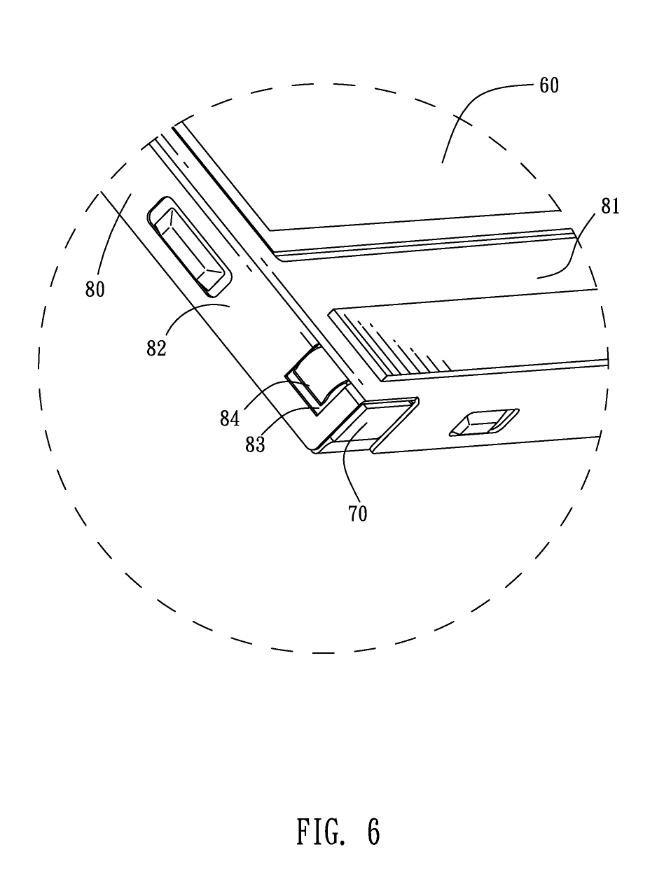

Please refer to FIG. 5 and FIG. 6, a liquid crystal module 3 of the third embodiment according to the present invention is shown. The liquid crystal module 3 has a rectangular liquid crystal panel 60, a plastic frame 70 enclosing a periphery of the liquid crystal panel 60 and a metal shell 80 of shielding effect coupled with the frame 70. The metal shell 80 is rectangular and defines a top surface 81 and a lateral surface 82 perpendicular to the top surface 81. The lateral surface 82 has a rectangular hole 83 reaching to the top surface 81 of the metal shell 80. The rectangular hole 83 has a side adjacent to the top surface 81 extended downwards and obliquely and bent toward the rectangular hole 83 to form an aseismatic portion 84 of arc shape. When the liquid crystal module 3 knocks against the outer hard component, the aseismatic portion 84 will contact the outer hard component foremost to make the aseismatic portion 84 had a movement in the rectangular hole 83, which is effective to buffer an impacting force applied to the liquid crystal module 3. Consequently, the liquid crystal panel 60 avoids the intense shock to damage internal components thereof.

Furthermore, the present invention is not limited to the embodiment described above; various additions, alterations and the like may be made within the scope of the present invention by a person skilled in the art. For example, respective embodiments may be appropriately combined.

What is claimed is:

1. A liquid crystal module, comprising:
a liquid crystal panel;
a plastic frame enclosing a periphery of the liquid crystal panel;
a metal shell coupled with the plastic frame; and
wherein a plurality of aseismatic portions are protruded outwards from at least one of the plastic frame and the metal shell, the aseismatic portions being capable of contacting an outer hard means foremost and being resiliently compressed.

2. The liquid crystal module in claim 1, wherein the frame is rectangular and has four grooves arranged at four corners of a top surface thereof, four elastic arms each extend from a side of the groove and suspend over the corresponding groove thereof, the aseismatic portion is extended upwards from a free end of the elastic arm.

3. The liquid crystal module in claim 2, wherein the aseismatic portion is formed with a semi-sphere shape.

4. The liquid crystal module in claim 1, wherein a lateral side of the plastic frame has a portion extended outwards and bent towards the corresponding lateral side to form the aseismatic portion of arc shape.

5. The liquid crystal module in claim 4, wherein the aseismatic portion has a free end of substantially flat slice shape attached on the corresponding lateral side and capable of sliding freely thereon.

6. The liquid crystal module in claim 1, wherein the metal shell defines a top surface and a lateral surface perpendicular to the top surface, the lateral surface has a rectangular hole reaching to the top surface of the metal shell, the rectangular hole has a side adjacent to the top surface extended downwards and obliquely and bent toward the rectangular hole to form the aseismatic portion of arc shape.

7. The liquid crystal module as claimed in claim 1, wherein the plastic frame is rectangular, the aseismatic portions are located at two ends of each of two opposite long sides of the plastic frame.

8. The liquid crystal module as claimed in claim 1, wherein the metal shell is rectangular, the aseismatic portions are located at two ends of each of two opposite long sides of the metal shell.
